(19) United States
(12) Patent Application Publication
(10) Pub. No.: US 2021/0300793 A1
(43) Pub. Date: Sep. 30, 2021

(54) WATER DISINFECTION SYSTEM

(71) Applicant: Xylem Europe GmbH, Schaffhausen (CH)

(72) Inventors: Leroy Jack Morningstar, Jr., Charlotte (US); Birk Roehring, Bünde (DE); Nicolas Rose, Minden (DE)

(73) Assignee: Xylem Europe GmbH, Schaffhausen (CH)

(21) Appl. No.: 17/264,918

(22) PCT Filed: Aug. 2, 2019
(86) PCT No.: PCT/EP2019/070888

§ 371 Date: Feb. 1, 2021

(30) Foreign Application Priority Data
Aug. 2, 2018 (EP) 18186996.7

(51) Int. Cl. C02F 1/32

(52) U.S. Cl. CPC C02F 1/325; C02F 2303/04; C02F 2303/14; C02F 2201/3227; C02F 2201/326; C02F 2201/3225

(57) ABSTRACT

A water disinfection system with a flow-through treatment chamber, a plurality of elongated ultraviolet lamps positioned parallel to each other in at least one array within the treatment chamber, and a stand-alone frame which holds in place the lamps of the array and which is constructed so that all lamps of the array can be lifted out of the chamber simultaneously. The array is disposed so that the water must pass through the array. The frame has a cuboid outer shape, an upstream end including front frame members, a downstream end including rear frame members, and a frame center section including side frame members. The array is contained inside the cuboid shape and the frame is positioned in the chamber in an unguided manner and has attachment elements for attaching the frame to a lifting mechanism.

The present invention relates to a water disinfection system with the features of the preamble of claim 1.

Disinfection systems for water and wastewater treatment utilizing ultraviolet radiation are known in the art and are in wide-spread use. The size of the systems ranges from single lamp installations, which are connected directly to a point of use, to systems with hundreds of UV lamps for the disinfection of effluents of municipal wastewater or for the drinking water supply of cities.

Systems are generally described such that they comprise ultraviolet radiators in the form of gas discharge UV lamps of different kinds, mainly in the form of low pressure mercury amalgam lamps. These lamps are provided with a surrounding protective sleeve made of UV transparent glass or quartz which prevent direct contact of the lamp body with the water. In the present context, the assembly of a radiator and the sleeve tube will simply be referred to as a “lamp”.

A part of the systems are constructed as open channel systems, in which the water flows inside a channel with concrete bottom and side walls. The systems are sized so that a number of lamps can be disposed in a parallel arrangement in a direction transverse to the flow of water forcing the water to pass between adjacent lamps so that the radiation intensity is sufficiently high even in wider channels. The arrangement of lamps in parallel groups is commonly called an array. The lamps in the array are inclined with respect to the water flow in an acute angle, which allows the relatively long lamps to be placed in a channel with a depth less than the length of the lamps.

Other known systems, which are not elements of the closest prior art, utilize vertical or horizontal lamp arrays.

Arrays are held in frames which first of all hold the lamps securely in place, and, in many cases, secondly allow the placement and retrieval of the array into and out of the channel.

Known systems that allow the retrieval of the arrays from the channel by lifting the frame utilize a guiding system that guides the respective frame during the lifting or lowering process and that additionally defines a certain position of the frame in and out of the channel. Such guiding systems include linear rails and hinges which hold the frame when being lifted. The guiding system may include a dedicated drive means, or the lifting may be effected manually or by use of a crane.

In the prior art, U.S. Pat. No. 5,564,765 discloses a system in which lamps are arranged in a vertical orientation, hence the necessary depth of the channel is large.

U.S. Pat. No. 5,208,461 and WO 2012/079149 A1 show systems with inclined lamp which are held in frames. The frames are mounted in hinges, so that the frames with the lamps can be tilted upwards out of the channel. The raised position of the frame is determined by the hinge geometry.

The patent application US 2016/0304362 discloses a system with inclined lamps which are mounted to frames. The frames are guided in linear guide rails and can be raised out of the channel in the direction of the rails, which are parallel to the lamps. Again, the position of the raised frame is defined by the geometry of the guide rails. Furthermore, each frame needs a dedicated rail system, which adds to the total cost of the system.

It is therefore an object of the present invention to provide a water disinfection system with the features of the preamble of claim 1, which is more cost-efficient in production and maintenance. It is another object of the present invention to provide a water disinfection system with the features of the preamble of claim 1 which can be lifted out of the channel and placed into the channel without dedicated guide elements and thus, when lifted out of the channel, can be placed at any convenient position so that access to the frame and the array of lamps as well as their maintenance can more easily be carried out.

These objects are achieved by a water disinfection system with the features of claim 1. Further advantageous features are the subject matter of the dependent claims, individually or in combination.

A water disinfection system comprising
a flow-through treatment chamber with an inlet and an outlet for the water in an open channel, the inlet and the outlet defining a flow direction of a flow of water,
a plurality of elongated ultraviolet lamps positioned parallel to each other in at least one array within said treatment chamber which at least one array is disposed at an acute angle with respect to and transverse to the flow of water so that the water must pass through the array,
a frame which holds in place the lamps of the array and which is constructed so that all lamps of the at least one array can be lifted out of the chamber simultaneously by lifting the frame, is further improved in that
the frame is a stand-alone frame with a cuboid outer shape, the frame having in the direction of the flow of water:
   an upstream end with two vertical front frame members and two horizontal front frame members,
   a downstream end with two vertical rear frame members and two horizontal rear frame members, and
   a frame centre section with two lower side frame members and two upper side frame members,
wherein the at least one array is contained inside the cuboid shape and
wherein the frame is positioned in the chamber and has attachment elements for attaching the frame to a lifting mechanism. Therefore, the frame can be positioned in the channel and lifted out of the channel in an unguided manner, i.e. without the need for guide rails or hinges. Especially, the use of one single crane for a complex system with plurality of frames becomes possible. Savings in installation and maintenance costs are given, and the increase with the number of frames in the installation.

The acute angle is preferably in the range between 30 to 60 degrees, especially between 40 and 50 degrees.

In a preferred embodiment, the frame, when being lifted by the lifting mechanism, is freely movable in the direction of the flow of water and in the vertical direction, and especially the frame is not fixed to the chamber. The frame can then simply be lowered into the channel and remain there by its own weight. There is no need for any installations on the channel walls.

For an easy and secure attachment to a crane harness, the attachment elements are positioned at the four upper corners of the frame.

Preferably, the attachment points are eyelets or openings, for example in the form of rings or oval openings similar to the corner castings known from shipping containers.

The UV radiation can efficiently penetrate the water when the frame has an open front face, an open rear face, open side faces and optionally also an open bottom face. Thus, the radiation can impinge onto the channel walls with only minimal shadowing in the areas covered by the members defining the outer cuboid shape of the frame.

For better access and saving of material, the upper face of the frame between the horizontal members may open and, in operation, covered with a top cover to prevent the emission of UV radiation to the environment.

The top cover may co-operate with a safety switch so that the electric supply to the lamps is cut when the top cover is lifted or otherwise removed or opened.

It is furthermore preferred that, in its operating position on top of the frame, the top cover covers one or more of the attachment elements so that the frame can only be lifted out of the channel when the top cover is removed.

This way, the frame can only be attached to the crane harness and lifted from the channel when the power supply to the UV lamps is cut off.

Generally, the position of the required electronics can freely be chosen. The choice may depend upon the size of the equipment, the space that is available and the tolerable length of the cables. However, in a preferred embodiment, an electronics unit is positioned above the upper face of the frame, the electronics unit comprising ballasts for driving the lamps and/or lamp wiper drivers, so that only very few connections from the frame to the facilities that are placed beside the channel are necessary.

Another preferred embodiment may be advantageous because of easier access to the electronics. This embodiment is characterized in that an electronics unit is mounted in a cabinet, said cabinet being positioned adjacent to the channel and at a distance from the frame, the electronics unit comprising ballasts for driving the lamps and/or driving electronics for lamp wipers. The position of the cabinet may for example be chosen such that the cabinet is placed on the bank of the channel next to the frame or even in a dedicated building.

In the following, an embodiment of the present invention is described in greater detail with reference to the drawing, which show:

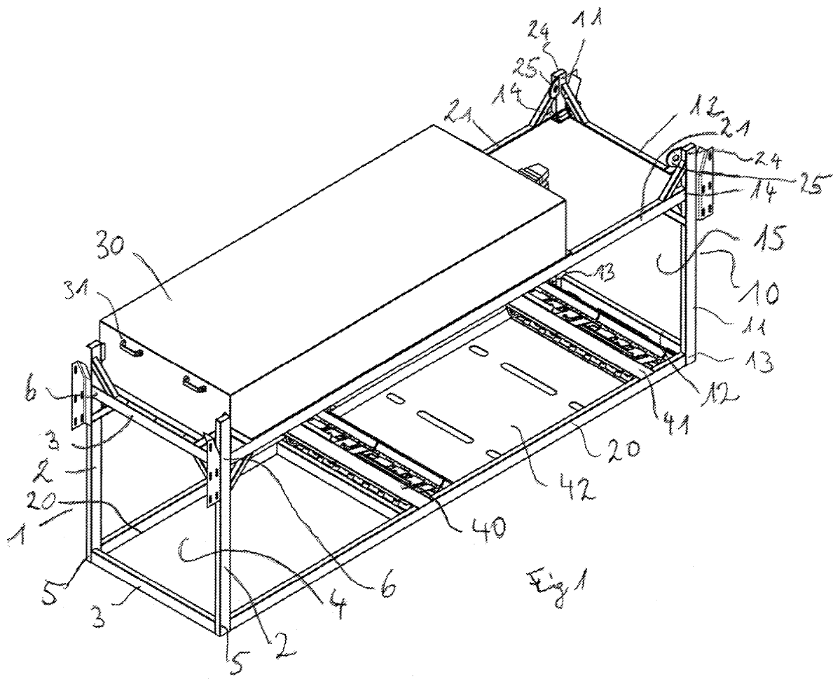

FIG. 1: a frame with top cover without lamp arrays,

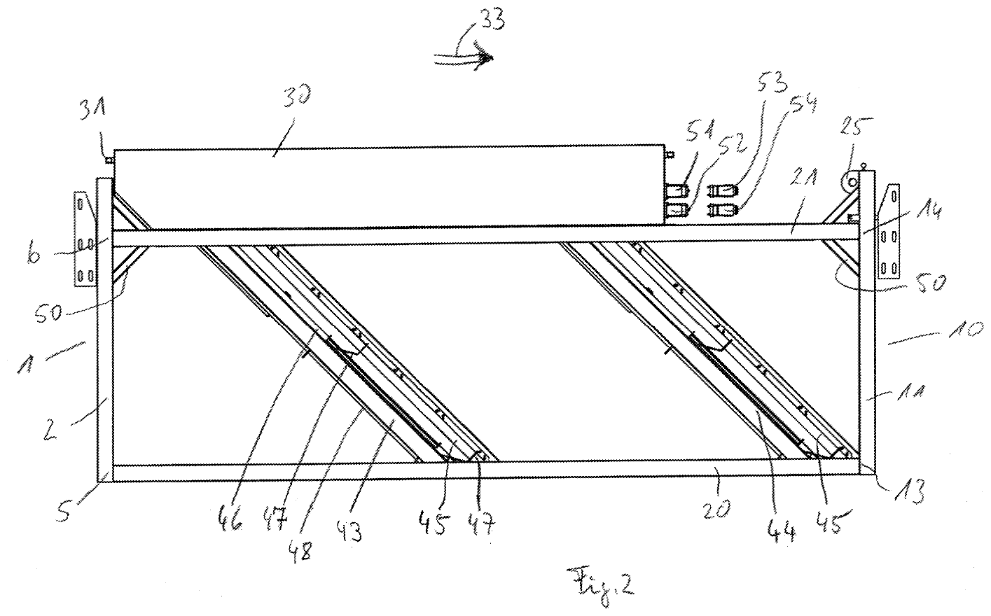

FIG. 2: the frame of FIG. 1 in a side view with two lamp arrays installed, and

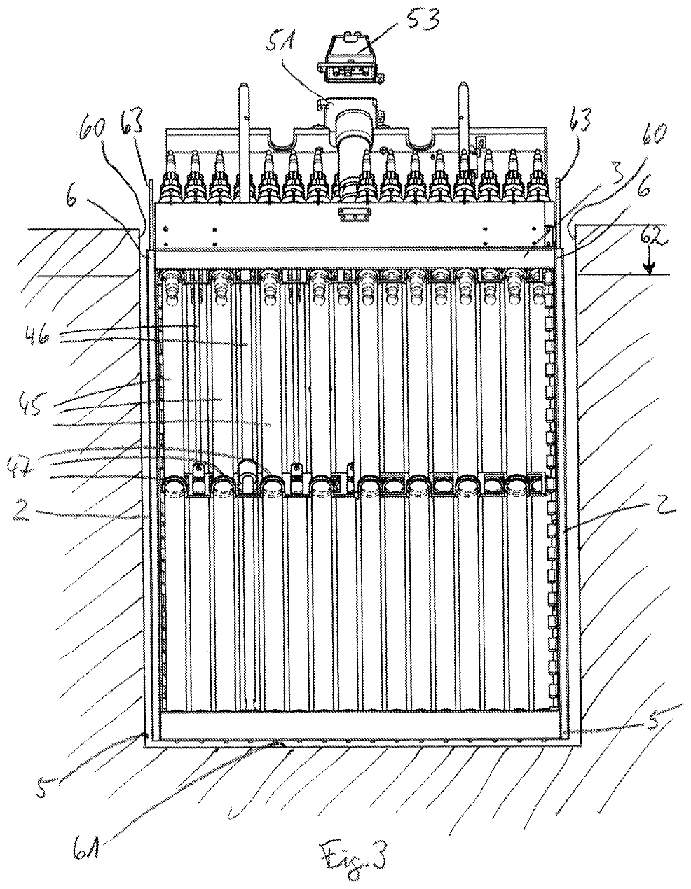

FIG. 3: the frame of FIG. 2, installed in a water treatment chamber of a channel, in a view in the direction of the water flow.

FIG. 1 shows the frame of a water disinfection system according to the present invention. The frame has an upstream end 1 with two vertical front frame members 2 and horizontal front frame members 3. The vertical front frame members 2 and the horizontal front frame members 3 are fixed to each other in a 90° angle and therefore define an almost quadratic open front face 4. The joints between the vertical front frame members 2 and the horizontal front frame members 3 define lower corners 5 and upper corners 6.

A downstream end 10, which is the end opposite the upstream end 1, is of a similar construction and comprises two vertical rear frame members 11 and two horizontal rear frame members 12, which are again fixed to each other in lower corners 13 and upper corners 14 in a 90° angle with respect to each other. Accordingly, an almost quadratic open rear face 15 is defined by the two vertical rear frame members and the two horizontal rear frame members.

A frame centre section extends between the upstream end 1 and the downstream end 10. The centre section comprises two lower side frame members 20 and two upper side frame members 21. The lower side frame members 20 extend from the upstream lower corners 5 to the downstream lower corners 13 and define a 90° angle with the adjacent front frame members and rear frame members. Similarly, the upper side frame members 21 extend from the upstream upper corners 6 to the downstream upper corners 14 and are fixed at a right angle to the respective front and rear members. In total, the members of the frame define an essentially cuboid outer shape.

The vertical rear frame members 11 extend in an upward direction beyond the rear upper corners 14 and, at their free ends 24, an eyelet 25 is fixed to each vertical rear frame member 11. Similarly, the vertical front frame members 2 extend in upwards direction beyond the front upper corners 6, and at their free ends, each vertical front frame member 2 carries an eyelet, which is not visible in FIG. 1. The front eyelets are hidden under a top cover 30 which is placed, in operation, on top of the frame and which is provided with handles 31 for manual lifting of the top cover 30. The top cover 30 covers drive means for mechanical cleaning devices (not shown in FIG. 1). Additionally, the top cover 30 prevents ultraviolet radiation from leaking into the environment by covering the frame at the top.

The top cover 30 intentionally also covers the front eyelets so that top cover 30 must be removed before fitting a crane harness to the front eyelets. The top cover 30 is connected to a safety switch which cuts off the electric supply to the ultraviolet lamp arrays and therefore guarantees that the ultraviolet radiation is shut down when the top cover is removed. Consequently, because removal of the top cover 30 is necessary to gain access to the front eyelets, these eyelets are also only accessible when the ultraviolet radiation is shut down.

At the bottom face of the frame, which is defined by the lower horizontal front frame member 3, the lower horizontal rear frame member 12 and the two lower horizontal side frame members 20, there is a first bracket 40 and a second bracket 41 extending between the two lower horizontal side frame members 20 and parallel to the lower horizontal front frame member 3. The bracket 40 serves as a holder for an upstream array of ultraviolet lamps, while the second bracket 41 serves as a holder for a second downstream array of ultraviolet lamps, both arrays are not shown in figure and will be referred to later on.

Between the first bracket 40 and the second bracket 41, there may be a plate 42 which covers the bottom face of the frame in that section. However, this plate 42 may be omitted.

FIG. 2 shows the frame of FIG. 1 in a side view. The same or similar elements are designated with reference numerals.

In the representation of FIG. 2, the frame carries two lamp arrays, an upstream array 43 and a downstream array 44. The two arrays 43 and 44 are essentially identical in construction. The upstream array 43 will be described in greater detail. Upstream array 43 comprises a number of lamps 45. The lamps 45 are arranged parallel to each other and are lined up in a direction transvers to the flow of water, which is indicated by an arrow 33 above the frame. The line-up of lamps 45 is perpendicular to the plane of the drawing. Therefore, only the single lamp 45 which is next to the viewer, is visible in FIG. 2. A guide 46 holds a wiper assembly 47, which is used to clean the surface of the lamp 45 on a regular basis. In order to carry out the cleaning process, a drive means (not visible) is placed under the top cover 30 and is dedicated to each array of lamps. The drive means drives the wipers 47 along the guide 46 and wipes the surface of the lamp 45 in a longitudinal direction parallel to its axis of symmetry.

Additional means, for example strips 48 for guiding the water flow towards the lamps 45, are optional.

The lamps 45 and the guides 46 are, at the bottom of the frame, held in the bracket 40, which has been described with reference to FIG. 1 and which is, in this representation, hidden behind the lower side frame member 20. The top end of the lamp 45 and the guide 46 is firmly held in place by a similar bracket which is also hidden under the top cover 30.

Is should be noted that, at the corners 6 and 14, there are diagonal re-inforcement elements 50, which increase the stability of the frame.

It can be seen that, at the top cover 30, there are two sockets 51 and 52 for connecting the lamp arrays to a remote operating station, which may include a power supply and other drive and measuring means. Each socket 51 and 52 is contacted by a respective plug 53 and 54 so that only one single connection is necessary to connect each array to the remote power supply and drive. In this case, the first array 43, which is the upstream array, is connected through socket 51 to plug 53, while the second, downstream array 44 is connected through socket 52 to plug 54. Other embodiments, however, may have the electronic ballasts for the lamps placed in a separate cabinet next to the channel.

Whenever maintenance of the water disinfection system is necessary, it is only necessary to remove the two plugs 53 and 54 and the top cover 30 by using the handles 31 in order to open the frame at the top. Access to the top end of the arrays 43 and 44 is then possible. If necessary, further access to the lamp arrays 43 and 44 and the rest of the frame can be gained by attaching a crane harness to the eyelets 25 and the second set of eyelets which is hidden under the top cover 30 in operation, and subsequently lifting the whole frame out of the water treatment chamber and the channel.

The position of the frame inside the water treatment chamber and the relative position of the lamps of an array is better shown in FIG. 3, which represents a view on the installation of FIG. 2 in the direction of the water flow 33, which is perpendicular to the plane of the drawing.

FIG. 3 shows a view on the open front face 4 at the upstream end 1 of the frame and the first lamp array 43, which is visible therein. The frame is placed in an operating position inside a water treatment chamber which is defined by vertical side walls 60 and a bottom wall 61. The treatment chamber is open at its top. In operation, the water level may be regulated and rise up to a level indicated with an arrow 62. The channel and the treatment chamber are preferably made of concrete.

The top of the frame including the connections to a power supply through socket 51 and plug 53 has been described above. These connections are visible here because the top cover has been removed. It should be noted that now front or upstream eyelets 63 are visible, which were covered in FIGS. 1 and 2.

When installing the frame with the arrays in the water treatment chamber, a crane harness is fixed to the attachment elements, which in this embodiment are eyelets 25 and 63. The frame can then be lifted from the ground beneath the channel, or from a truck on which the frame has been delivered, using a mobile or stationary crane. Then, the frame can be lowered into the treatment chamber as shown in FIG. 6 and simply be placed on the bottom wall 61 to rest there. An abutment (not shown) may be installed in the channel to prevent unwanted movement of the frame in a downstream direction. After releasing the harness, the top cover 30 may be put in place to close the top of the installation. Then, plugs 53 and 54 can be connected to sockets 51 and 52 and the system can be powered up.

It should be understood that, depending on the requirements, a number of frames can be placed in a line one behind another in the direction of flow, and also beneath each other transverse to the direction of flow. In the latter case, the width of the treatment chamber has to be adapted.

1-11. (canceled)

12. A water disinfection system comprising:
a flow-through treatment chamber, including an inlet and an outlet for water in an open channel, the inlet and the outlet defining a flow direction of a flow of water;
a plurality of elongated ultraviolet lamps positioned parallel to each other in at least one array within the chamber, the at least one array disposed at an acute angle with respect to and transverse to the flow of water, such that the flow of water passes through the at least one array; and
a stand-alone frame with a cuboid outer shape, the frame configured to hold in place the plurality of lamps of the at least one array inside the cuboid shape so that all of the plurality of lamps of the at least one array are removable from the chamber simultaneously by removal of the frame, the frame positioned in the chamber in an unguided configuration and having attachment elements for attaching the frame to a lifting mechanism configured to lift the frame from the chamber in a vertical direction, the frame having an upstream end and a downstream end relative to the flow of water, and a center section disposed between the upstream end and the downstream end:
the upstream end having two vertical front frame members, an upper horizontal front frame member and a lower horizontal front frame member,
the center section having two lower side frame members and two upper side frame members, and
the downstream end having two vertical rear frame members, an upper horizontal rear frame member, and a lower horizontal rear frame member;

13. The water disinfection system of claim 12, wherein the frame is freely movable by the lifting mechanism in the direction of the flow of water and in the vertical direction.

14. The water disinfection system of claim 12, wherein the frame is not fixed to the chamber.

15. The water disinfection system of claim 12, wherein the attachment elements are positioned at four upper corners of the frame.

16. The water disinfection system of claim 12, wherein the attachment elements comprise eyelets or openings.

17. The water disinfection system of claim 12, wherein the frame has an open front face, an open rear face, open side faces, and an open bottom face.

18. The water disinfection system of claim 12, comprising an open upper face of the frame defined by the two upper side frame members, the upper horizontal front frame member, and the upper horizontal rear frame member.

19. The water disinfection system of claim 18, further comprising a top cover configured to cover the open upper face of the frame during an operating phase of the water disinfection system.

20. The water disinfection system of claim 19, comprising a safety switch in co-operation with the top cover, the safety switch configured to interrupt an electric supply to the lamps when the top cover is lifted or otherwise removed or opened relative to the upper face of the frame.

21. The water disinfection system of claim 19, wherein the top cover has an operating position on the frame in which the top cover covers one or more of the attachment elements.

22. The water disinfection system of claim 19, further comprising an electronics unit, wherein the electronics unit includes (a) ballasts for driving the lamps, driving electronics for lamp wipers, or a combination thereof, and (b) is positioned above the upper face of the frame.

23. The water disinfection system of claim 12, further comprising an electronics unit, wherein the electronics unit (a) includes ballasts for driving the lamps, driving electronics for lamp wipers, or a combination thereof, (b) is mounted in a cabinet, and (c) is positioned adjacent to the channel and at a distance from the frame.
